(19) United States
(12) Patent Application Publication
(10) Pub. No.: US 2021/0282191 A1
(43) Pub. Date: Sep. 9, 2021

(54) METHOD PERFORMED BY USER EQUIPMENT, AND USER EQUIPMENT

(71) Applicants: SHARP KABUSHIKI KAISHA, Sakai City, Osaka (JP); FG Innovation Company Limited, Tuen Mun, New Territories (HK)

(72) Inventors: NINGJUAN CHANG, Shanghai (CN); RENMAO LIU, Shanghai (CN)

(21) Appl. No.: 17/255,822

(22) PCT Filed: Jun. 26, 2019
(86) PCT No.: PCT/CN2019/093006

§ 371 Date: Dec. 23, 2020

(30) Foreign Application Priority Data
Jun. 29, 2018 (CN) 201810705724.4

(51) Int. Cl. H04W 74/08; H04W 16/18

(52) U.S. Cl. CPC H04W 74/0833; G16Y 10/75; H04W 16/18

(57) ABSTRACT

A method performed by user equipment, comprising: receiving a random access channel (RACH) report request from a base station; and reporting, by the user equipment, a RACH report to the base station upon receiving the RACH report request from the base station, the RACH report indicating RACH performance of the user equipment for an enhanced coverage level and/or early data transmission (EDT).

### TECHNICAL FIELD

The present invention relates to the field of wireless communications technologies. More specifically, the present invention relates to a method performed by user equipment, and corresponding user equipment.

### BACKGROUND

Network optimization can be performed in a wireless network to achieve the goal of optimizing network performance. Generally, techniques such as data acquisition and data analysis are used to ascertain the causes of poor network quality in existing deployed and operating networks, and techniques such as modifying configured network parameters and adjusting the network structure and deployed devices are adopted to improve network performance. In a self-configuration and self-optimization network, optimization refers to a process of automatically adjusting the network on the basis of measurement/performance measurement of user equipment and/or a base station. The network side can configure the UE to perform measurement for a SON. There are many SON functions, for example, an Automatic Neighbour Relation (ANR) function for reducing the neighbour management burden of an operator, a Mobility Load Balancing (MLB) function for balancing loads between different cells, a Mobility Robustness Optimization (MRO) function for optimizing the mobility performance of a user, a random access channel optimization function for optimizing random access channel parameters, and a radio link failure report function for optimizing coverage and MRO.

A new project for further enhancement of NarrowB and Internet of Things (NB-IoT) (see RP-181451: New WID on R16 enhancement for NB-IoT) was approved at the 3rd Generation Partnership Project (3GPP) RAN #80 plenary meeting held in June 2018. One of the goals of this research project is to realize SON functions in an NB-IoT network, including ANR, random access channel performance, and radio link failure reporting for MRO.

The present invention aims to solve the problem of how to achieve appropriate random access channel performance of SON functions in an NB-IoT network, and further solve the problem of how to feed back a random access channel report more precisely.

### SUMMARY OF INVENTION

The present invention is provided in order to solve at least part of the aforementioned problems in the prior art. The present invention can provide a method performed by user equipment, and user equipment, enabling a base station to obtain a more precise RACH report, so as to perform RACH parameter adjustment more accurately based on precise information in the RACH report, thereby improving RACH performance.

In order to achieve the aforementioned objective, according to the present invention, a method performed by user equipment is provided, comprising: receiving a random access channel (RACH) report request from a base station; and reporting, by the user equipment, a RACH report to the base station upon receiving the RACH report request from the base station, the RACH report indicating RACH performance of the user equipment for an enhanced coverage level and/or early data transmission (EDT).

Preferably, the RACH report comprises: a first information element, for indicating the number of random access preambles transmitted by a medium access control (MAC) layer in a last successfully completed random access procedure; and a second information element, for indicating whether contention was detected or whether contention resolution was successful for at least one transmitted random access preamble of each used enhanced coverage level in the last successfully completed random access procedure.

Preferably, the RACH report comprises: a first information element, for indicating the number of random access preambles transmitted by a medium access control (MAC) layer in a last successfully completed random access procedure; a third information element, for indicating whether contention was detected or whether contention resolution was successful for at least one transmitted random access preamble in the last successfully completed random access procedure; and a fourth information element, for indicating a initial enhanced coverage level of the user equipment in the last successfully completed random access procedure.

The RACH report comprises: a first information element, for indicating the number of random access preambles transmitted by a medium access control (MAC) layer in a last successfully completed random access procedure; a third information element, for indicating whether contention was detected or whether contention resolution was successful for at least one transmitted random access preamble in the last successfully completed random access procedure; and a fifth information element, for indicating the number of enhanced coverage levels used or tried by the user equipment in the last successfully completed random access procedure.

Preferably, the RACH report comprises: a first information element, for indicating the number of random access preambles transmitted by a medium access control (MAC) layer in a last successfully completed random access procedure; a third information element, for indicating whether contention was detected or whether contention resolution was successful for at least one transmitted random access preamble in the last successfully completed random access procedure; and a sixth information element, for indicating the number of random access preambles transmitted by the MAC layer corresponding to each used enhanced coverage level in the last successfully completed random access procedure.

Preferably, the RACH report further comprises at least one of the following information elements: a seventh information element, for indicating the number of random access preambles transmitted by a medium access control (MAC) layer for EDT in a last successfully completed random access procedure; an eighth information element, for indicating whether contention was detected or whether contention resolution was successful for at least one transmitted random access preamble of each used enhanced coverage level for EDT in the last successfully completed random access procedure; a ninth information element, for indicating whether contention was detected or whether contention resolution was successful for at least one transmitted random access preamble for EDT in the last successfully completed random access procedure; a tenth information element, for indicating an initial coverage enhancement level of the user equipment for EDT in the last successfully completed random access procedure; an eleventh information element, for indicating the number of enhanced coverage levels used or tried by the user equipment for EDT in the last successfully completed random access procedure; and a twelfth information element, for indicating the number of random access preambles transmitted by the MAC layer for EDT corresponding to each used enhanced coverage level in the last successfully completed random access procedure.

Preferably, the second information element is represented by a contention detection list or bitmap.

Preferably, the eighth information element is represented by a contention detection list or bitmap.

Preferably, the RACH report is comprised in a user equipment information response message.

In addition, according to the present invention, user equipment is further provided, comprising: a processor; and a memory, storing instructions, wherein the instructions, when run by the processor, perform the method described above.

According to the present invention, a base station can obtain a more precise RACH report, so as to perform RACH parameter adjustment more accurately based on precise information in the RACH report, thereby improving RACH performance.

### BRIEF DESCRIPTION OF DRAWINGS

FIG. 1 is a flowchart of a method performed by user equipment according to Embodiment 1 of the present invention.

FIG. 2 is a flowchart of a method performed by user equipment according to Embodiment 2 of the present invention.

FIG. 3 is a flowchart of a method performed by user equipment according to Embodiment 3 of the present invention.

FIG. 4 is a flowchart of a method performed by user equipment according to Embodiment 4 of the present invention.

FIG. 5 is a flowchart of a method performed by user equipment according to Embodiment 5 of the present invention.

FIG. 6 is a block diagram of user equipment (UE) involved in an embodiment of the present invention.

### DETAILED DESCRIPTION OF EMBODIMENTS

The following describes the present invention in detail with reference to the accompanying drawings and specific embodiments.

In the present invention, the terms “include” and “comprise” and derivatives thereof mean inclusion without limitation; the term “or” has an inclusive meaning and means “and/or.”

In the present specification, the following various embodiments for describing the principles of the present invention are merely illustrative, and should not be interpreted in any way as limiting the scope of the disclosure. The following description, which references the accompanying drawings, is used to facilitate full understanding of the exemplary embodiments of the present invention as defined by the claims and equivalents thereof. The following description includes a variety of specific details to facilitate understanding, but these details should be considered merely exemplary. Therefore, those of ordinary skill in the art should recognize that various changes and modifications may be made to the embodiments described herein without departing from the scope and spirit of the present invention. In addition, the description of the known function and structure is omitted for clarity and simplicity. In addition, the same reference numerals are used for similar functions and operations throughout the accompanying drawings.

A plurality of embodiments according to the present invention are specifically described below by using a Long Term Evolution (LTE) mobile communication system and its subsequent evolved version as an exemplary application environment. However, it should be noted that the present invention is not limited to the following embodiments, and may be applied to other wireless communication systems such as a machine type communication (MTC) system, and may also be applied to a 5G next-generation wireless communication system (New Radio, NR).

In the present invention, the base station may be a base station of any type, including a Node B, an enhanced base station eNB, a base station gNB in a 5G communication system, a micro base station, a picocell base station, a macro base station, or a home base station; the cell may also be a cell covered by any type of base station described above. In the present invention, if not specified, a coverage enhancement level is equivalent to an enhanced coverage level or a repetition level.

Different embodiments can also be combined with each other for operation.

Certain concepts relating to the present invention are described first below. It is worth noting that some names in the following description are merely illustrative of examples rather than limiting, and other names may be used.

### Early Data Transmission (EDT):

A small data transmission optimization scheme in R15 further optimizes characteristics of small data transmission in terms of the control plane and user plane. For uplink data transmission, optimization mainly involves small data transmission along with Message 3 in a random access procedure. Compared with a conventional data transmission method, this optimization method can complete data transmission at an earlier point in time, and thus is referred to as early data transmission. In the present invention, small data (or small packet) may be equivalent to early data.

Enhanced coverage level: the degree to which coverage needs to be enhanced is divided into a plurality of enhanced coverage levels in the coverage enhancement technology; for example, three enhanced coverage levels are defined in NB-IoT. In some coverage enhancement methods, each enhanced coverage level may correspond to a set of different wireless parameter configurations, such as random access configurations (for example, PRACH (Physical Random Access Channel) resources). When initiating random access, a medium access control layer of UE determines an enhanced coverage level of the UE according to measured RSRP and an RSRP threshold used for determining an enhanced coverage level and received in system information, and selects a corresponding random access resource (for example, a preamble) and parameter (for example, a random access response window size) according to the determined enhanced coverage level to initiate a random access procedure. Enhanced coverage level ramping may occur in one random access procedure. That is, if the number of random access preambles transmitted by the UE at an enhanced coverage level N reaches or exceeds a set maximum, but the random access procedure has not been successful, the UE is considered to enter a subsequent enhanced coverage level N+1, that is, one in which a random access parameter corresponding to the enhanced coverage level N+1 is used to continue the random access procedure.

Physical random access channel resource: Physical Random Access Channel (PRACH) resource. A base station broadcasts a physical random access channel parameter configuration list (see the NPRACH-ParametersList-NB information element in 3GPP protocol specifications 36.331) on each carrier via system information. The physical random access channel parameter configuration list on each carrier includes physical random access channel parameter configurations (see the NPRACH-Parameters-NB information element in 3GPP protocol specifications 36.331) of one or a plurality of coverage enhancement levels, that is, one coverage level corresponds to a set of physical random access channel parameter configurations. This set of physical random access channel parameter configurations is referred to as one physical random access channel resource (PRACH resource). In NB-IoT, the PRACH resource is also referred to as an NPRACH resource. The physical random access channel resource may refer to a physical frequency resource and/or time-domain resource and/or code-domain resource (for example, a preamble) for random access.

Random access channel: Random Access Channel, RACH. The RACH refers to a channel for transmitting a random access preamble. In the present invention, a RACH can refer to a transport channel RACH or can refer to a physical random access channel (PRACH). RACH parameters/configurations refer to wireless configurations for implementing random access functions, including PRACH related configurations, for example, a maximum number of preambles transmitted, a power ramping parameter, a random access response receiving window size, a MAC contention resolution timer configuration, and a PRACH resource configuration.

In an LTE system, for RACH performance in SON functions, a base station sends a UEinformationRequest message to UE, the message includes a RACH report request indication (rach-reportreq information element) which is used to request the UE to report a RACH report of a random access procedure. After receiving the UEinformationRequest message including the indication, the UE reports the RACH report to the base station in a UEinformationReponse message. The base station uses a RACH report reported by one UE as a sample, and with sufficient samples, the base station can analyze whether the current RACH performance meets requirements, and adjust RACH parameters according to the requirements to improve RACH performance. The RACH report includes two parts: one is the number of random access preambles transmitted (numberofpreamblesent), which is used for indicating the number of random access preambles transmitted in the random access procedure and which corresponds to a PREAMBLE_TRANSMISSION_COUNTER count value of a MAC layer; the other is a contention detection indication (contentiondetected), which is used for indicating whether contention was detected for at least one transmitted random access preamble. The RACH parameters that can be adjusted by the base station may include RACH resource configuration, random access preamble division (for example, division into dedicated preambles, or dividing preambles into group A and group B), a RACH backoff parameter, a RACH transmit power control parameter, and so on.

Compared with conventional LTE random access, random access in an NB-IoT system is based on enhanced coverage levels. That is, parameters of different coverage enhancement levels are separately configured, UE at different coverage enhancement levels uses RACH parameters of corresponding coverage enhancement levels to perform random access procedures, and enhanced coverage level ramping occurs in one random access procedure; that is, the UE uses RACH parameters corresponding to more than one enhanced coverage level to perform random access in one random access procedure. If a RACH report of SON functions in the LTE system is directly used, the base station cannot tell which RACH parameter/parameters the RACH report is directed to. The base station side cannot perform more precise analysis on a received sample, and thus cannot determine which coverage enhancement level/levels should have RACH parameters adjusted and how to adjust them, resulting in inaccurate or even erroneous optimization of RACH parameters. In addition, in EDT introduced in Release15, RACH parameters of EDT are configured separately from RACH parameters of conventional non-EDT. With this configuration, the base station needs to separately adjust and optimize RACH performance for EDT and RACH performance for non-EDT. Moreover, for UE currently performing an EDT random access procedure, if a received uplink grant for transmitting Message 3 is not for EDT, the UE cancels EDT and backs off to the non-EDT mode, and employs the non-EDT mode in the subsequent random access procedure. That is, a single random access procedure may include both an EDT stage and a non-EDT stage, but RACH reporting in existing LTE systems cannot support RACH reports with greater detail. As a result, the base station cannot know whether, a received RACH report sample is applicable to RACH performance optimization for EDT or for non-EDT, which may cause inaccurate RACH performance optimization.

Therefore, the present invention focuses on how to implement a more precise RACH report, and more specifically, how to implement a more precise RACH report that considers coverage enhancement level and/or EDT. The following embodiments of the present invention provide specific implementations for solving this problem. By means of the solutions of the present invention, the base station can obtain a more precise RACH report so as to perform RACH parameter adjustment more accurately based on precise information in the RACH report, thereby improving RACH performance.

In the following embodiments of the present invention, “indicate/indication”, “notify/notification” and “inform/information” are interchangeable. “UE” may refer to NB-IoT UE, bandwidth reduced low complexity (BL) UE, UE in enhanced coverage, or other UE such as 5G NR UE. In the present invention, “PRACH”, “NPRACH”, and “RACH” are interchangeable.

### Embodiment 1

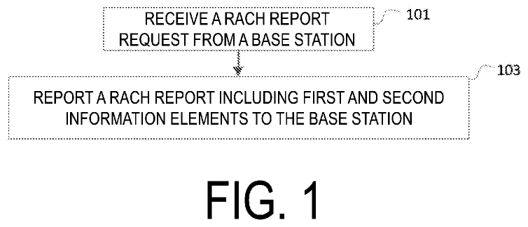

FIG. 1 is a flowchart of a method performed by user equipment according to Embodiment 1 of the present invention.

Embodiment 1 provides a RACH report mode that includes enhanced coverage level information.

As shown in FIG. 1, in step 101, the UE receives a RACH report request from a base station.

Upon receiving the RACH report request, the UE reports a RACH report to the base station, as shown in step 103. At this time, the UE sets the content of the RACH report (namely, a rach-report information element) as follows:

set a first information element (for example, numberofpreamblesent) to indicate the number of random access preambles transmitted by a MAC layer in a last (most recent) successfully completed random access procedure;

set a value of a corresponding field in a second information element to “TRUE” or “1”, if contention was detected or contention resolution is unsuccessful for at least one transmitted random access preamble for each used enhanced coverage level in the last (most recent) successfully completed random access procedure; otherwise, set the value of the corresponding field in the second information element to “FALSE” or “0”, or do not include the second information element in the RACH report. That is, the second information element includes contention resolution information corresponding to enhanced coverage levels used or associated in one or a plurality of random access procedures. For example, a contention detection list may be included, where each contention detection item in the list may correspond to one enhanced coverage level and be used for indicating that contention was detected or contention resolution is unsuccessful for at least one transmitted random access preamble of the corresponding enhanced coverage level. Alternatively, the second information element is a bitmap, where each bit corresponds to a contention detection field of one enhanced coverage level, where if a bit is set to 1, it indicates that contention was detected or contention resolution is unsuccessful for at least one transmitted random access preamble of a corresponding enhanced coverage level, and if the bit is set to 0, it indicates that no contention was detected or contention resolution was successful for all transmitted random access preambles of the corresponding enhanced coverage level.

Preferably, the UE includes the RACH report in a UEinformationresponse message.

Optionally, after receiving the RACH report request of the base station, the UE reports the RACH report. For example, if the RACH report request (rach-reportreq) received by the UE is set to “true,” the UE sets the content of the RACH report according to the above and reports the RACH report to the base station. Preferably, a RACH report request indication used by the base station to request reporting by the UE is included in a UEinformationrequest message.

The present invention does not place any limitations on a radio resource control (RRC) message including the aforementioned request or report.

By means of the method of Embodiment 1, the base station can combine the content of the first information element and the second information element to obtain RACH performance of the UE corresponding to each used enhanced coverage level in the random access procedure, so as to more precisely perform RACH parameter adjustment and RACH performance optimization based on different enhanced coverage levels.

### Embodiment 2

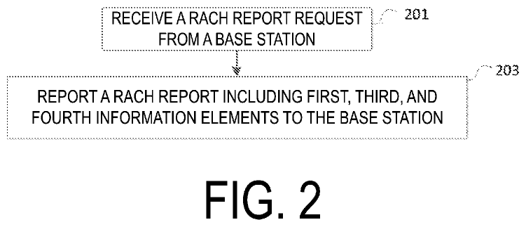

FIG. 2 is a flowchart of a method performed by user equipment according to Embodiment 2 of the present invention.

Embodiment 2 provides another RACH report mode that includes enhanced coverage level information.

As shown in FIG. 2, in step 201, the UE receives a RACH report request from a base station.

Upon receiving the RACH report request, in step 203, the UE reports a RACH report to the base station. At this time, the UE sets the content of the RACH report (namely, a rach-report information element) as follows:

set a first information element (for example, numberofpreamblesent) to indicate the number of random access preambles transmitted by a MAC layer in a last (most recent) successfully completed random access procedure;

set a value in a third information element to “TRUE” or “1”, if contention was detected or contention resolution is unsuccessful for at least one transmitted random access preamble in the last (most recent) successfully completed random access procedure; otherwise, set the value in the third information element to “FALSE” or “0”, or do not include the third information element in the RACH report;

set a value of a fourth information element (staringCElevel) to indicate an initial coverage enhancement level of the UE for the last (most recent) successfully completed random access procedure. The initial coverage enhancement level of the UE refers to a coverage enhancement level of the UE when the random access procedure starts, or a coverage enhancement level corresponding to a first random access preamble transmitted by the MAC layer in the random access procedure, or a coverage enhancement level determined by the MAC layer according to link signal quality (namely, RSRP) when the random access procedure is initiated. Alternatively, the fourth information element is absent if enhanced coverage level ramping/change does not occur in the random access procedure.

Preferably, the UE includes the RACH report in a UEinformationresponse message.

Optionally, after receiving the RACH report request of the base station, the UE reports the RACH report. For example, if the RACH report request (rach-reportreq) received by the UE is set to “true,” the UE sets the content of the RACH report according to the above and reports the RACH report to the base station. Preferably, a RACH report request indication used by the base station to request reporting by the UE is included in a UEinformationrequest message.

The present invention does not place any limitations on a radio resource control (RRC) message including the aforementioned request or report.

By means of the method in Embodiment 2, the base station can combine the content of the first information element, the third information element, and the fourth information element to obtain RACH performance of the UE corresponding to each used enhanced coverage level in the random access procedure, so as to more precisely perform RACH parameter adjustment and RACH performance optimization based on different enhanced coverage levels.

### Embodiment 3

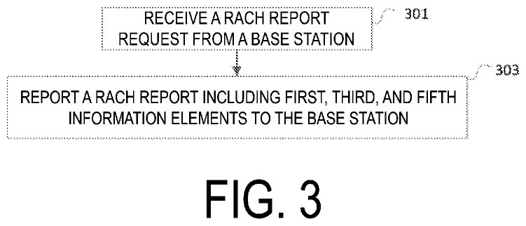

FIG. 3 is a flowchart of a method performed by user equipment according to Embodiment 3 of the present invention.

Embodiment 3 provides still another RACH report mode that includes enhanced coverage level information.

As shown in FIG. 3, in step 301, the UE receives a RACH report request from a base station.

Upon receiving the RACH report request, the UE reports a RACH report to the base station, as shown in step 303. At this time, the UE sets the content of the RACH report (namely, a rach-report information element) as follows:

set a first information element (for example, numberofpreamblesent) to indicate the number of random access preambles transmitted by a MAC layer in a last (most recent) successfully completed random access procedure;

set a value in a third information element to “TRUE” or “1”, if contention was detected or contention resolution is unsuccessful for at least one transmitted random access preamble in the last (most recent) successfully completed random access procedure; otherwise, set the value in the third information element to “FALSE” or “0”, or do not include the third information element in the RACH report;

set a fifth information element (numberofCElevelused) to indicate the number of enhanced coverage levels used or tried by the UE in the last (most recent) successfully completed random access procedure, namely, the number of all enhanced coverage levels corresponding to all RACH resources that are used by the UE in the random access procedure. For example, an initial enhanced coverage level when the UE initiates a random access procedure is 0, but enhanced coverage level ramping occurs due to a random access response receiving failure or unsuccessful random access contention resolution, so that the UE continues to use a random access resource having an enhanced coverage level of 1 to perform random access, and then enhanced coverage level ramping occurs again, so that the UE uses a random access resource having an enhanced coverage level of 2 to perform random access, and the random access procedure is successful. Then, in this random access procedure, the UE uses RACH resources corresponding to the enhanced coverage level 0, the enhanced coverage level 1, and the enhanced coverage level 2 to perform random access, and the number of the enhanced coverage levels used by the UE is 3. Therefore, in this example, the fifth information element is set to 3.

Preferably, the UE includes the RACH report in a UEinformationresponse message.

Optionally, after receiving the RACH report request of the base station, the UE reports the RACH report. For example, if the RACH report request (rach-reportreq) received by the UE is set to “true,” the UE sets the content of the RACH report according to the above and reports the RACH report to the base station. Preferably, a RACH report request indication used by the base station to request reporting of the UE is included in a UEinformationrequest message.

The present invention does not place limitations on a radio resource control (RRC) message including the aforementioned request or report.

By means of the method in Embodiment 3, the base station can combine the content of the first information element, the third information element, and the fifth information element to obtain RACH performance of the UE corresponding to each used enhanced coverage level in the random access procedure, so as to more precisely perform RACH parameter adjustment and RACH performance optimization based on different enhanced coverage levels.

### Embodiment 4

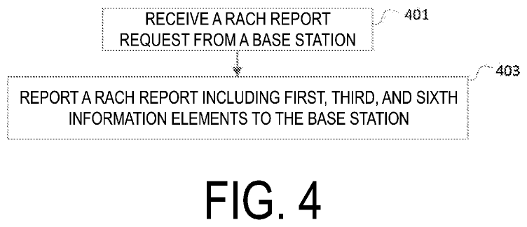

FIG. 4 is a flowchart of a method performed by user equipment according to Embodiment 4 of the present invention.

Embodiment 4 provides still another RACH report mode that includes enhanced coverage level information.

As shown in FIG. 4, in step 401, the UE receives a RACH report request from a base station.

Upon receiving the RACH report request, the UE reports a RACH report to the base station, as shown in step 403. At this time, the UE sets the content of the RACH report (namely, a rach-report information element) as follows:

set a first information element (for example, numberofpreamblesent) to indicate the number of random access preambles transmitted by a MAC layer in a last (most recent) successfully completed random access procedure;

set a value in a third information element to “TRUE” or “1”, if contention was detected or contention resolution is unsuccessful for at least one transmitted random access preamble in the last (most recent) successfully completed random access procedure; otherwise, set the value in the third information element to “FALSE” or “0”, or do not include the third information element in the RACH report;

set a sixth information element (for example, numberofpreamblesentCElevellist) to indicate the number of random access preambles transmitted by the MAC layer corresponding to each used enhanced coverage level in the last (most recent) successfully completed random access procedure. That is, the sixth information element includes a list, where each item in the list corresponds to one enhanced coverage level and is used for indicating the number of transmitted random access preambles of the corresponding enhanced coverage level in the random access procedure. Preferably, the number of the items in the list is the number of enhanced coverage levels used or tried by the UE in the random access procedure. Alternatively, the number of the items in the list is the maximum number of enhanced coverage levels supported by the system, such as 3 in an NB-IoT system.

Preferably, the UE includes the RACH report in a UEinformationresponse message.

Optionally, after receiving the RACH report request of the base station, the UE reports the RACH report. For example, if the RACH report request (rach-reportreq) received by the UE is set to “true,” the UE sets the content of the RACH report according to the above and reports the RACH report to the base station. Preferably, a RACH report request indication used by the base station to request reporting of the UE is included in a UEinformationrequest message.

The present invention does not place limitations on a radio resource control (RRC) message including the aforementioned request or report.

By means of the method in Embodiment 4, the base station can combine the content of the first information element, the third information element, and the sixth information element to obtain RACH performance of the UE corresponding to each used enhanced coverage level in the random access procedure, so as to more precisely perform RACH parameter adjustment and RACH performance optimization based on different enhanced coverage levels.

### Embodiment 5

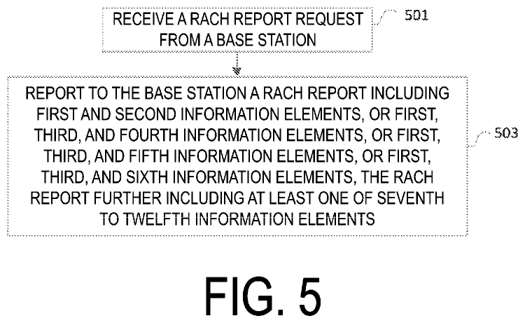

FIG. 5 is a flowchart of a method performed by user equipment according to Embodiment 5 of the present invention.

Embodiment 5 provides a RACH report mode that includes EDT information.

As shown in FIG. 5, in step 501, the UE receives a RACH report request from a base station.

Upon receiving the RACH report request, the UE reports a RACH report to the base station, as shown in step 503.

In Embodiment 5, when reporting the RACH report, the UE sets the content in the RACH report differently for EDT and non-EDT. This differentiation between EDT and non-EDT may be applied for the first to sixth information elements in the aforementioned Embodiments 1 to 4.

That is, the UE sets the content in the RACH report as follows:

set a first information element and a second information element as described in Embodiment 1;

set a first information element, a third information element, and a fourth information element as described in Embodiment 2;

set a first information element, a third information element, and a fifth information element as described in Embodiment 3; and

set a first information element, a third information element, and a sixth information element as described in Embodiment 4.

Additionally, the UE may include at least one of the following information for EDT in the RACH report:

set a seventh information element (for example, numberofpreamblesent-EDT) to indicate the number of random access preambles transmitted by the MAC layer for EDT in the last (most recent) successfully completed random access procedure;

set a value of a corresponding field in an eighth information element to “TRUE” or “1”, if contention was detected or contention resolution is unsuccessful for at least one transmitted random access preamble for each used enhanced coverage level for EDT in the last (most recent) successfully completed random access procedure; otherwise, set the value of the corresponding field in the eighth information element to “FALSE” or “0”, or do not include the eighth information element in the RACH report. That is, the eighth information element includes contention resolution information corresponding to enhanced coverage levels used or associated in one or a plurality of random access procedures. For example, a contention detection list may be included, where each contention detection item in the list may correspond to one enhanced coverage level and be used for indicating that contention was detected or contention resolution is unsuccessful for at least one transmitted random access preamble of the corresponding enhanced coverage level for EDT. Alternatively, the eighth information element is a bitmap, where each bit corresponds to a contention detection field of one enhanced coverage level, where if a bit is set to 1, it indicates that contention was detected or contention resolution is unsuccessful for at least one transmitted random access preamble of a corresponding enhanced coverage level for EDT, and if the bit is set to 0, it indicates that no contention was detected or contention resolution was successful for all transmitted random access preambles of the corresponding enhanced coverage level for EDT;

set a value in a ninth information element to “TRUE” or “1”, if contention was detected or contention resolution is unsuccessful for at least one transmitted random access preamble for EDT in the last (most recent) successfully completed random access procedure; otherwise, set the value in the ninth information element to “FALSE” or “0”, or do not include the ninth information element in the RACH report;

set a value of a tenth information element (staringCElevel-EDT) to indicate an initial coverage enhancement level of the UE for EDT in the last (most recent) successfully completed random access procedure. The initial coverage enhancement level of the UE refers to a coverage enhancement level of the UE when the random access procedure starts, or a coverage enhancement level corresponding to a first random access preamble transmitted by the MAC layer in the random access procedure, or a coverage enhancement level determined by the MAC layer according to link signal quality (namely, RSRP) when the random access procedure is initiated;

set an eleventh information element (numberofCElevelused-EDT) to indicate the number of enhanced coverage levels used or tried by the UE for EDT in the last (most recent) successfully completed random access procedure. That is, the number of all enhanced coverage levels corresponding to all RACH resources that are used by the UE for EDT in the random access procedure. For example, an initial enhanced coverage level when the UE initiates a random access procedure is 0, but enhanced coverage level ramping occurs due to a random access response receiving failure or unsuccessful random access contention resolution, so that the UE continues to use a random access resource having an enhanced coverage level of 1 to perform random access, but the UE cancels EDT and backs off to a non-EDT mode because the UE receives an uplink grant for Message 3 transmission that is not for EDT, and if enhanced coverage level ramping occurs again, the UE uses a random access resource having an enhanced coverage level of 2 to perform random access, and the random access procedure is successful. Then, in this random access procedure, the UE uses RACH resources for EDT corresponding to the enhanced coverage level 0 and the enhanced coverage level 1 to perform random access, and the number of the enhanced coverage levels for EDT used by the UE is 2. Therefore, in this example, the fifth information element is set to 2;

set a twelfth information element (for example, numberofpreamblesentCElevellist-EDT) to indicate the number of random access preambles transmitted by the MAC layer for EDT corresponding to each used enhanced coverage level in the last (most recent) successfully completed random access procedure. That is, the twelfth information element includes a list, where each item in the list corresponds to one enhanced coverage level and is used for indicating the number of transmitted random access preambles for EDT of the corresponding enhanced coverage level in the random access procedure. Preferably, the number of the items in the list is the number of enhanced coverage levels for EDT used or tried by the UE in the random access procedure. Alternatively, the number of the items in the list is the maximum number of enhanced coverage levels supported by the system, such as 3 in an NB-IoT system.

### Embodiment 6

Embodiment 6 provides still another RACH report mode that includes enhanced coverage level information.

The UE sets the content of the RACH report (namely, a rach-report information element) as follows:

set a first information element (for example, numberofpreamblesent) to indicate the number of random access preambles transmitted by a MAC layer in a last (most recent) successfully completed random access procedure;

set a value in a third information element to “TRUE” or “1”, if contention was detected or contention resolution is unsuccessful for at least one transmitted random access preamble in the last (most recent) successfully completed random access procedure; otherwise, set the value in the third information element to “FALSE” or “0”, or do not include the second information element in the RACH report;

set a thirteenth information element (for example, CElevelramping) to indicate that coverage enhancement level ramping occurs in the last (most recent) successfully completed random access procedure, or random access resources used in the random access procedure are associated with more than one coverage enhancement level;

set a fourteenth information element (for example, startCElevel0 or startCElevel1) to indicate that an initial coverage enhancement level of the random access procedure is a coverage enhancement level 0 or a coverage enhancement level 1, or to indicate that a coverage enhancement level corresponding to a first transmitted random access preamble in the random access procedure is a coverage enhancement level 0 or a coverage enhancement level 1.

Preferably, the UE includes the RACH report in a UEinformationresponse message.

Optionally, after receiving the RACH report request of the base station, the UE reports the RACH report. For example, if the RACH report request (rach-reportreq) received by the UE is set to “true,” the UE sets the content of the RACH report according to the above and reports the RACH report to the base station. Preferably, a RACH report request indication used by the base station to request reporting of the UE is included in a UEinformationrequest message.

The present invention does not place limitations on a radio resource control (RRC) message including the aforementioned request or report.

By means of the method in Embodiment 6, the base station can combine the content of the first information element, the third information element, and the thirteenth and fourteenth information elements to obtain RACH performance of the UE corresponding to each used enhanced coverage level in the random access procedure, so as to more precisely perform RACH parameter adjustment and RACH performance optimization based on different enhanced coverage levels.

It is worth noting that the information elements included in the RACH report are all optional. That is, the UE may report any combination of one or more of the information elements in the RACH report.

In addition, in the present disclosure, the random access procedure may be the last (most recent) successfully completed random access procedure described in the embodiments or a (most recent) failed random access procedure. For the latter, for example, when the UE fails in a random access procedure for RRC connection establishment/recovery, the UE includes random access information of a random access failure corresponding to a connection establishment failure in a connection establishment failure report (ConnEstFailReport). At this time, the first to fourteenth information elements in the aforementioned embodiment may be included in the connection establishment failure report to indicate corresponding information of the failed random access procedure. If the UE has a connection establishment failure report saved thereon, the UE reports connection failure information availability indication through an RRC message to inform the base station that the UE has a connection establishment failure report saved thereon or the UE has experienced a connection establishment failure. Based on this indication, the base station requests the UE to report the saved connection establishment failure report through an RRC message (which is usually UEinformationrequest) including a connection establishment failure report request information element, and the UE receiving the request reports the connection establishment failure report saved thereon in a response RRC message. Thus, in the present disclosure, the aforementioned method for a RACH report is also applicable to a connection establishment failure report.

It is worth noting that in the aforementioned embodiments, the step in which the UE receives a RACH report request from the base station is optional. For this step, the RACH report request may also be included in a random access response message (namely) or an RRC connection establishment/recovery/reestablishment message (namely, a fourth message in a random access procedure). In one implementation, the RACH report request may also be included in system information to indicate that the UE is allowed to report a RACH report or request the UE to report the RACH report. Preferably, when the RACH report request is included in system information, the UE is UE that supports (employs) a user plane optimization mechanism and/or UE that supports (employs) a control plane optimization mechanism; or the UE is UE that supports (employs) a user plane optimization EDT mechanism (namely, UP-EDT) and/or UE that supports (employs) a control plane optimization EDT mechanism (namely, CP-EDT).

In one implementation, the UE includes one or more of the second to fourteenth information elements in the RACH report when enhanced coverage level ramping/change occurs in the random access procedure. The occurrence of enhanced coverage level ramping/change may also be understood as random access resources used in the random access procedure, such as random access preambles, being associated with a plurality of NPRACH resources, namely, a plurality of coverage enhancement levels. Otherwise, the UE does not include the second to fourteenth information elements (that is, the information elements are absent) in the RACH report.

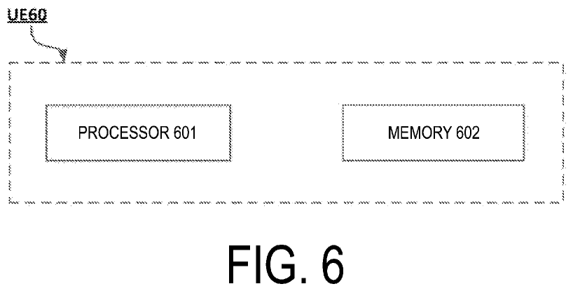

FIG. 6 is a block diagram of user equipment (UE) involved in an embodiment of the present invention. As shown in FIG. 6, the user equipment (UE) 60 includes a processor 601 and a memory 602. The processor 601 may include, for example, a microprocessor, a microcontroller, or an embedded processor. The memory 602 may include, for example, a volatile memory (for example, a random access memory (RAM)), a hard disk drive (HDD), a non-volatile memory (for example, a flash memory), or other memories. The memory 602 stores program instructions. The instructions, when run by the processor 601, can perform the aforementioned method performed by user equipment described in detail in the present disclosure.

The program running on the device according to the present invention may be a program that enables the computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing them by the computer system. The phrase “computer system” herein may refer to a computer system embedded in the device, which may include operating systems or hardware (for example, peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of the advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-4. (canceled)

5. A User Equipment (UE), comprising:
a processor; and
a memory, wherein the memory stores instructions that cause the processor to:
receive, from a base station, a UEinformationRequest message including a random access report request set to TRUE, the random access report request being used to request the UE to report a random access report; and
transmit, to the base station, a UEinformationResponse message including the random access report, an information in the random access report being set to indicate an initial coverage enhancement level used for the last successfully completed random access procedure.

6. A control method in a User Equipment (UE), comprising:
receiving, from a base station, a UEinformationRequest message including a random access report request set to TRUE, the random access report request being used to request the UE to report a random access report; and
transmitting, to the base station, a UEinformationResponse message including the random access report, an information in the random access report being set to indicate an initial coverage enhancement level used for the last successfully completed random access procedure.

7. A Base Station, comprising:
a processor; and
a memory, wherein the memory stores instructions that cause the processor to:
transmit, to a User Equipment (UE), a UEinformationRequest message including a random access report request set to TRUE, the random access report request being used to request the UE to report a random access report; and
receive, from the UE, a UEinformationResponse message including the random access report, wherein an information in the random access report indicates an initial coverage enhancement level used for the last successfully completed random access procedure.

8. A control method in a Base Station, comprising:
transmitting, to a User Equipment (UE), a UEinformationRequest message including a random access report request set to TRUE, the random access report request being used to request the UE to report a random access report; and
receiving, from the UE, a UEinformationResponse message including the random access report, wherein an information in the random access report indicates an initial coverage enhancement level used for the last successfully completed random access procedure.
